(19) United States
(12) Patent Application Publication
(10) Pub. No.: US 2002/0158963 A1
(43) Pub. Date: Oct. 31, 2002

(54) Information transfer device and method of exposing printable photosensitive films/papers in a printing machine for electronically readable information storage

(76) Inventor: Martin Dietze, Langen (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 10/134,148

(22) Filed: Apr. 29, 2002

(30) Foreign Application Priority Data
Apr. 27, 2001 (DE) 101 20 752.2

(51) Int. Cl. B41J 2/45

(52) U.S. Cl. 347/238

(57) ABSTRACT

An information transfer device includes a rotary main cylinder and a rotary guide cylinder pressed against it. The cylinders define a contact nip therebetween through which a recording material with photosensitive properties is guidable for transferring information. A non-rotary light source is disposed in the main cylinder and directed towards the contact nip. The main cylinder has a periphery predominantly translucent to light from the light source. A device selectively inputs light into the recording material with photosensitive properties. A method of transferring information with the transfer device, recording material processable through the transfer device and a hand-held reader for reading the information on the recording material are also provided.

### BACKGROUND OF THE INVENTION

1. Field of the Invention:

The invention relates to an information transfer device and a method of exposing printable photosensitive films/papers in a printing machine for electronically readable information storage, and also to a recording material suitable for this purpose, and a corresponding hand-held reader.

An information transfer device of the foregoing general type has become known heretofore, for example, from gravure printing technology, wherein a sheet is guided in a printing nip between an impression cylinder and a printing form cylinder. A rotating form cylinder dips into an ink trough and, in the printing nip, transfers with ink the printing image applied on the side of the circumference to the sheet impressed by the rotating impression cylinder.

The published German Patent Document DE 195 44 099 A1 discloses a thermographic printing device wherein at least one heat source, for example, a laser light source, is provided, having thermal action directed to a selective transfer of ink onto a recording material on an ink carrier. For this purpose, the printing device has a hollow glass cylinder serving as the ink carrier, which makes contact with the paper sheet by having the sheet pressed against the glass cylinder with the aid of an impression cylinder. In the region of the printing nip between the glass cylinder and the impression cylinder, at least one laser light source is arranged in the interior of the glass cylinder which is translucent. The laser light can be controlled so that, over the width of the glass cylinder in the region of the printing nip, the ink located on the surface of the glass cylinder can be melted selectively. For this purpose, small cell-like depressions are formed in the surface of the glass cylinder.

U.S. Pat. No. 4,957,580 discloses a method of producing an optical data card, wherein a laser unit selectively irradiating a one cm2-large photosensitive layer, which is applied to a card provided with positioning strips, in accordance with the information to be transferred, and therefore selectively exposing the layer. In this regard, the storage of information is implemented by a selective change in the optical reflective properties of the storage layer. Also provided is a reading unit, for example, having photodiodes, which can read the stored information out again via an optical arrangement.

Furthermore, the compact disk or CD has become known heretofore as a widespread information storage medium. Depending upon the embodiment, it is readable only or also readable and writeable. The CD is distinguished by a high storage capacity, fast access and favorable price. The drawback with the use of the CD is that the information can be visualized on the monitor for the user only with a complex CD drive and a PC.

Also generally known are photopolymer films which, for example, are used for the storage of holograms.

### SUMMARY OF THE INVENTION

It is an object of the invention to provide a new information transfer device and a corresponding information transfer method which expand the possible uses of paper-bound or film-bound information carriers.

With the foregoing and other objects in view, there is provided, in accordance with one aspect of the invention, an information transfer device, comprising a rotary main cylinder and a rotary guide cylinder pressed against it, the cylinders defining a contact nip therebetween through which a recording material with photosensitive properties is guidable for transferring information, a non-rotary light source disposed in the main cylinder and directed towards the contact nip, the main cylinder having a circumference predominantly translucent to light from the light source, and a device for selectively inputting light into the recording material with photosensitive properties.

In accordance with another feature of the invention, an elastic cover layer is disposed on the circumference of the rotary guide cylinder.

In accordance with a further feature of the invention, the light source is formed by a member selected from a group of members consisting of a controlled laser and a diode line.

In accordance with an added feature of the invention, the light source is an emitter of UV-light.

In accordance with an additional feature of the invention, the device for selectively inputting light is an exposure mask having the information to be transferred, the exposure mask being held on the circumference of the main cylinder.

In accordance with yet another feature of the invention, the exposure mask has a carrier plate which is translucent to the light from the light source and whereon a mask structure is provided.

In accordance with yet a further feature of the invention, the mask structure is covered with a protective layer.

In accordance with yet an added feature of the invention, the exposure mask has a thickness of about 0.1 to 0.4 mm.

In accordance with a more specific feature of the invention, the exposure mask has a thickness of about 0.15 to 0.3 mm.

In accordance with another aspect of the invention, there is provided a method of transferring information, which comprises storing information on a photosensitive recording material, guiding the recording material between a rotating main cylinder and a rotating guide cylinder, and selectively exposing the recording material in a manner suitable for transferring the information in a contact nip between the two cylinders.

In accordance with a further mode, the method of the invention further comprises applying the photosensitive recording material to a sheet at least approximately similar to paper before exposing the recording material.

In accordance with an added mode, the method of the invention further comprises initially exposing the sheet in a modified first printing unit, and then printing the sheet in a further printing unit.

In accordance with a further aspect of the invention, there is provided a recording material serving as raw material for photosensitive storage and conventional printing with data, comprising, as a first data carrier, a printable first subarea region at least similar to one of paper and film and, as a photosensitive second data carrier, a second subarea region.

In accordance with another feature of the invention, the second data carrier of the recording material is embedded in the first data carrier.

In accordance with a concomitant aspect of the invention, there is provided a hand-held reader for information stored in a photosensitive data carrier, comprising a housing, a reading unit, an input unit and an output unit carried by the housing, and a control unit in the housing, via which the reading unit, the input unit and the output unit are connected to one another.

Applications of the information transfer device according to the invention are advantageous when a printed product, together with electronically readable general and/or personalized information with an average amount of information is to be transmitted and communicated for fast access and at low cost. The method according to the invention combines the advantages of printed media and digital information storage, wherein the direct communication via the printed product, and fast digital information access at low price play a major role. The combination according to the invention of printed product and electronically readable information permits direct and multimedia communication with the reader. The information storage is implemented in a photosensitive layer of the film/paper, which can be read out electronically at any time by an optical method. In addition to the storage of information, the film/paper can also be printed on conventionally, as a result of which, high acceptance by the reader and in the advertising is to be expected. In addition, paper is a conventional material, which can be handled simply and can have images formed thereon in conventional printing machines. The information can be read via a small optoelectronic hand-held reader with a mini-flat monitor which is suitable for multimedia and optionally also permits a link to the PC.

An exposure mask having the information to be transferred is preferably held on the circumference of the main cylinder for the purpose of selectively inputting light. This ensures that, by a device that is simple and correspondingly well known in printing technology, exact exposure of the photosensitive information carrier is possible. According to a preferred embodiment, provision is made for the exposure mask to have a thickness of about 0.1 to 0.4 mm, in particular, of about 0.15 to 0.3 mm and, to be produced, in particular, from a suitable plastic material. Consequently, the exposure mask has an adequate minimum strength and mechanical stability, and good elastic properties, moreover.

Use is advantageously made of a UV-light source and, therefore, high-energy light outside the visible range, in order to permit the handling of the sheet with the photosensitive area in the “printing process”, without difficulty.

In order to achieve good guidance of the recording material and to be able to compensate for different material thicknesses of the photosensitive film or of the sheet, provision is made for the guide cylinder to have an elastic cover layer on the circumference thereof.

According to a preferred embodiment of the method according to the invention, the exposure operation is carried out initially, and then followed by a printing operation. Consequently, in a manner advantageous in process terms, drying the printing ink in an operation before the exposure operation can be dispensed with.

Other features which are considered as characteristic for the invention are set forth in the appended claims.

Although the invention is illustrated and described herein as an information transfer device and a method of exposing printable photosensitive films/papers in a printing machine for storing electronically readable information, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings, wherein:

### BRIEF DESCRIPTION OF THE DRAWINGS

FIG. 1 is a diagrammatic side elevational view of the information transfer device according to the invention, showing the basic construction thereof, together with a conventional printing unit arranged downstream therefrom in the operating direction thereof;

FIG. 2 is an enlarged fragmentary view of FIG. 1, showing the information transfer device, with the cylinders thereof in reversed position, in the region of the contact nip or gap thereof;

FIG. 3 is an enlarged fragmentary view of FIG. 2, showing, in particular, recording material and exposure mask details;

FIG. 4 is a fragmentary further-enlarged view of FIG. 3, showing details of the exposure mask;

FIGS. 5a and 5b are fragmentary sectional views of respectively different exemplary embodiments of the recording material;

FIGS. 5c to 5e are plan views of respectively different further exemplary embodiments of the recording material; and

FIG. 6 is a diagrammatic and schematic sectional view of a hand-held reader shown in rather simple form for reading out phototechnically stored information from storage material.

### DESCRIPTION OF THE PREFERRED EMBODIMENTS

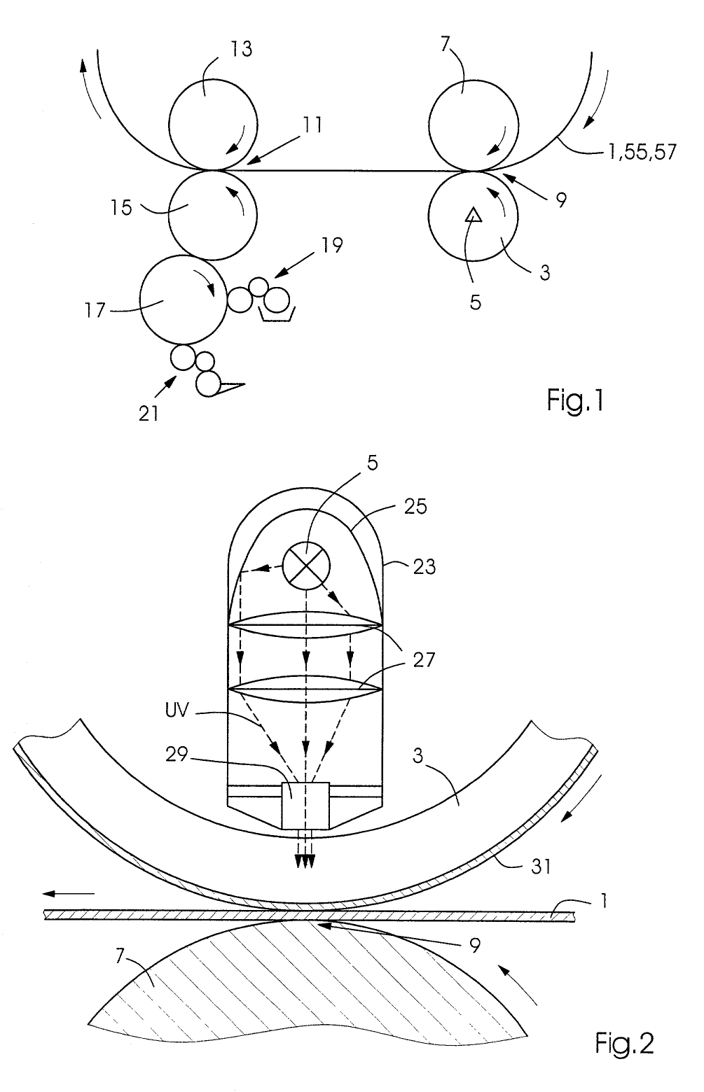

Referring now to the drawings and, first, particularly to FIG. 1 thereof, there are illustrated diagrammatically therein a phototechnical exposure operation using an information transfer device according to the invention, implemented by a modified first printing unit, and a printing operation connected downstream therefrom in at least one second ink printing unit of conventional construction. In this regard, as shown in FIG. 2, a special sheet 1 serving as a recording material is guided between a rotating main cylinder 3, with an ultraviolet or UV-light source 5 arranged therein, and a rotating guide cylinder 7 pressed against the main cylinder 3. The sheet 1 is selectively exposed by the UV-light source 5 in accordance with the information to be transferred in a contact or exposure nip or gap 9 formed between the two cylinders 3 and 7, and, as a result, the desired information is stored electronically or phototechnically in the sheet 1 so that it can be read out, as explained in greater detail hereinbelow. Following the exposure, the sheet 1 is guided into a printing nip 11 belonging to the heretofore known second printing unit and formed between an impression cylinder 13 and a rubber-covered or blanket cylinder 15. The printing image, which is to be printed onto the sheet 1 at a suitable location in the printing nip 11, is applied to the rubber-covered or blanket cylinder 15 in a conventional manner by a printing form cylinder 17. For this purpose, the nonprinting parts of the printing form are coated with a thin dampening-solution film by a dampening unit 19, and the printing form is then inked by an inking unit 21 in accordance with the printing image. Further possible units, such as a drying or a fixing or a development unit may be provided, however, they have not been illustrated, in the interest of simplicity. It is also believed to be obvious that other known printing units can be used for the printing operation.

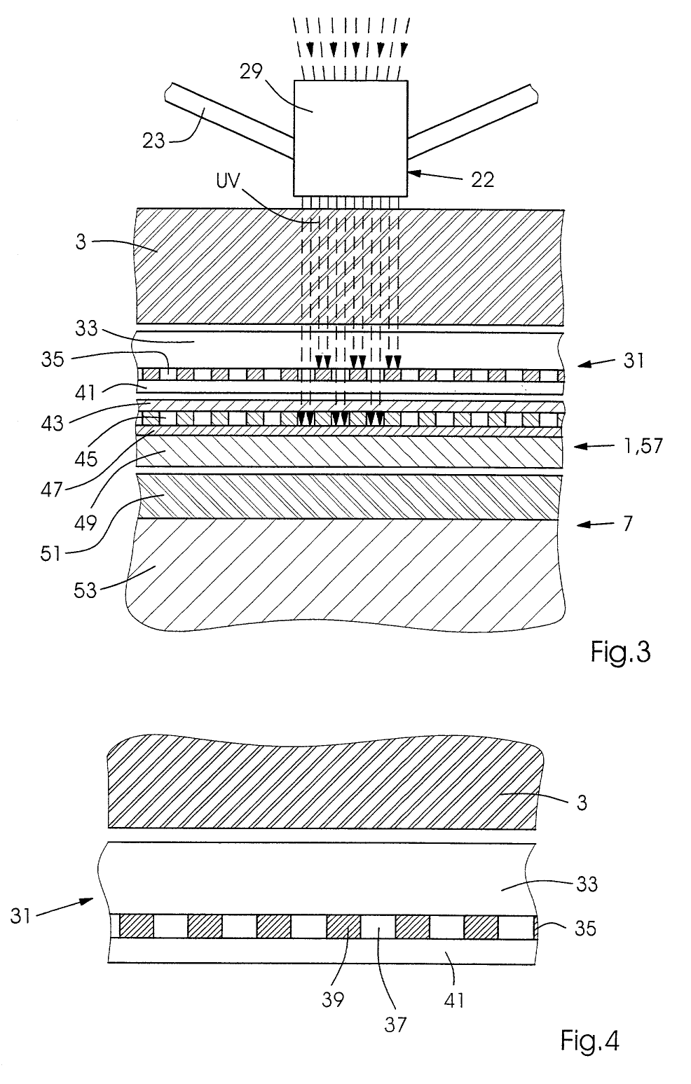

The information is written into a photosensitive layer 45 (note FIG. 3) of the sheet I by the high optical power UV-light source 5 in the modified first printing unit, and the process is illustrated in greater detail in FIGS. 2, 3 and 4. In this regard, the UV-light source 5 is in a locally fixed position in the interior of the rotating UV-translucent main cylinder 3 which, for example, is realized of quartz glass. The UV-light source 5 is completely encapsulated in a light source housing 23, except for a small gap-like opening 22, so that the UV-light can emerge in a defined manner in a direction towards the exposure nip 9, being restricted to the narrow gap opening 22. Provided in the light source housing 23 are a reflector 25, a first optical unit 27 formed as a lens system and a second optical unit 29 serving to focus the UV-light in the exposure nip 9. Thereby, the UV-light emitted by the light source 5 is collected optimally for a photosensitive layer 45, which is guided through the exposure nip 9 and is to be exposed, and is exactly focussed in order to avoid optical imaging errors or faults. The focussed UV-light passes through the translucent impression cylinder 3 and strikes an exposure mask 31 in the region of the exposure nip 9. The mask 31 is clamped, corresponding to a printing form known generally from printing technology, onto the main cylinder 3 in a precise position, fixed against rotation and so as to be readily replaceable (FIG. 2).

According to FIGS. 3 and 4, the exposure mask 31 is formed of a thin UV-translucent carrier plate 33, whereon a mask structure 35 with a pattern of UV-translucent locations 37 and UV-opaque locations 39 is applied, for example, in the form of a hole screen. The mask structure 35 is, in turn, completely covered with a thin UV-translucent protective layer 41. The thin protective layer 41 serves as a wear protection layer on the mask structure 35 and is intended for minimizing wear of the mask 31 during the exposure operation of the photosensitive film 57. In the replaceable exposure mask 31 and the mask structure 35, respectively, the information to be transferred is stored in a manner similar to that on a conventional printing plate. In this regard, the arrangement of the UV-translucent and opaque locations or points corresponds to digital encoding of the information to be stored, for example, corresponding to a punched-hole card used during the early days of computer technology. The exposure mask 31 is about 0.15 to 0.3 mm thick and is formed of a suitable plastic material or, if necessary or desirable, even of metal (FIG. 4). The exposure mask 31 is, in principle, clamped (not shown), like a printing plate known of itself, onto the UV-translucent main cylinder 3, by which the exposure mask 31 and the main cylinder 3 are positioned exactly in relation to one another and are detachably connected to one another. In order to keep optical imaging faults as small as possible, the exposure mask 31 is pressed in direct contact with the sheet 1 and the photosensitive film 57, respectively, (FIG. 3).

An alternative exposure method is provided by using a UV laser or a UV diode unit instead of the combination of the UV-light source 5 and the exposure mask 31. With the laser or diode unit, personalized information, i.e., information which is different every time, can be stored on the recording material. In this regard, the laser unit is driven so that, in accordance with the digitized information to be stored, appropriate locations or points in the photosensitive layer are exposed by the laser beam, and others are not exposed. Besides the known advantages of personalized information, however, the higher costs and the slower information transfer, as compared with the mask exposure technique, have to be taken into account. A combination of the two methods, namely mask exposure and laser exposure, is optimally suitable for storing, on the photosensitive layer 45 and the photosensitive film 57, respectively, both general information using the mask exposure technique and personalized information using the laser exposure technique (not shown).

In the mask exposure technique, the photosensitive film 57 moving through the exposure nip 9 formed between the main cylinder 3 and the guide cylinder 7 is then exposed, according to FIG. 3, at the locations at which the UV-light shines through the exposure mask 31 rotating with the main cylinder 3. The possible exposure time is relatively short, in this regard, for which reason it is necessary to select an appropriately powerful UV-light source 5. After the sheet 1 has left the exposure nip 9, the exposure has already been completed, because special developing is not required when suitable self-developing photosensitive layers are used. Treating the sheet 1 in a developer bath would be particularly problematical if the sheet 1 has properties similar to those of paper. A thermal treatment, respectively, before and after the exposure can be provided, if this is associated with method or cost advantages. The film and the paper, respectively, can then run through the further printing units and be printed conventionally with ink or inks, as illustrated in principle in FIG. 1. By this procedure, a printed product having additionally digitally readable data can be produced in one operation on the modified printing machine arrangement. It is particularly advantageous, in this regard, if, in the case of the mask exposure technique, the exposure operation is carried out before the printing operation, in order to protect the exposure mask 31 reliably against contamination by the printing ink 19.

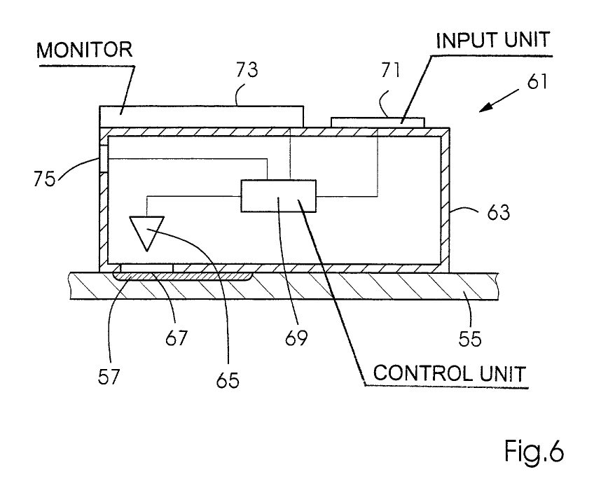

The digital information is stored in the special photosensitive layer 45 of the sheet 1 and a photosensitive film 57, respectively, which, for example, is realized by a UV-light sensitive photopolymer. The film 57 is formed of a UV-translucent covering layer 43, the photosensitive layer 45, a reflective layer 46 and a carrier layer 47, which are arranged above one another. Due to the exposure with the UV-light, structured in accordance with the information to be transferred by using the exposure mask 35, the transparence, reflective or refractive behavior of the photosensitive layer 45 on the film is changed permanently at the exposed locations, which effects the actual digital information storage. The reflective layer 47 under the photosensitive layer 45 ensures that the information is able subsequently to be read out again reliably with a reading unit 69 of a reader 61 (FIGS. 3 and 6). If the reflective properties of the photosensitive layer and the differences in the reflective behavior between irradiated and non-irradiated locations or points are sufficiently great enough, it is also possible to dispense with the reflective layer 47. A suitable film or paper, which can subsequently be printed in a conventional printing unit (FIG. 3), can be used as the carrier layer 49 and the carrier material, respectively.

The guide and impression cylinder 7, respectively, is constructed as an elastic rubber-covered roller with a soft roller-covering 51 and a hard roller-core 53 formed of steel, for example, in order to guide the photosensitive printing material 57 optimally between the main cylinder 3 and the guide cylinder 7 and, in particular, to be able to compensate suitably for dimensional deviations of the printing material 57 (FIG. 3).

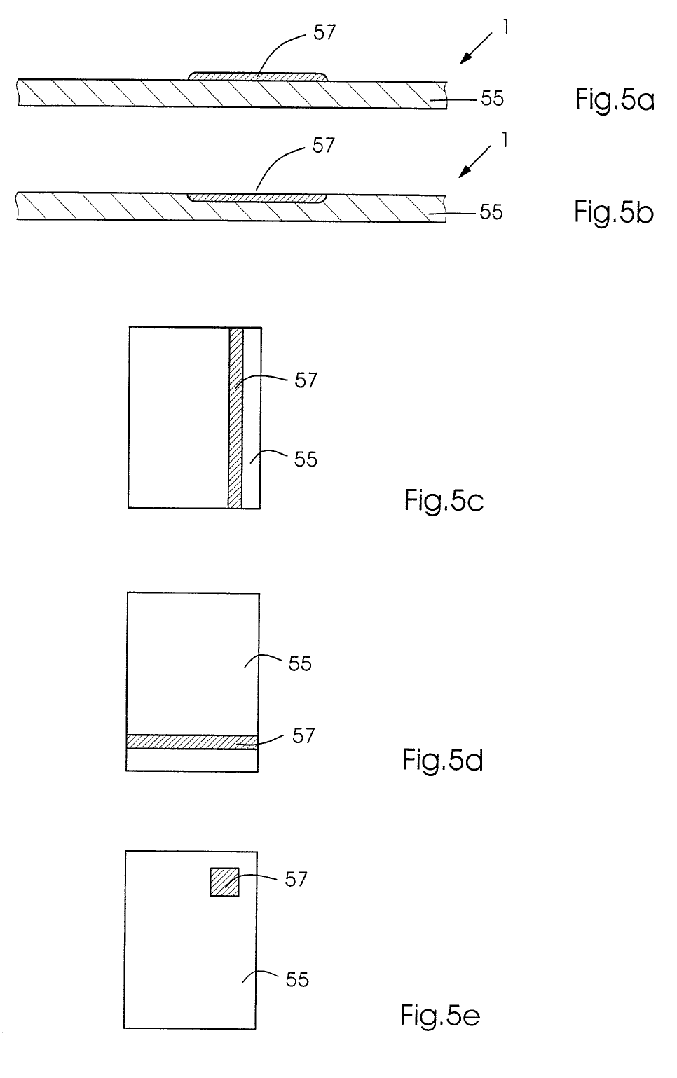

A composite or compound material formed of a paper 55 or pasteboard or printable film and the photosensitive film 57 can be used as material for the sheet 1. For example, according to FIG. 5a, the film 57 is adhesively bonded in strip form to the paper 55. A main advantage of the compound material is that it is possible to expose the photosensitive material and to print the paper in one operation in accordance with FIG. 1. Furthermore, cost advantages result, because the expensive photosensitive material 57 is provided only in the regions of the paper 55 which are actually needed for the digital data storage (FIGS. 5c to 5e). The sheet 1 is, therefore, conventionally printable as a first data carrier formed by the paper 55 in a first subarea region and equipped with a second data carrier and the photosensitive film 57, respectively, defined by the photosensitive layer 45 in a second subarea region. A mixed material for the sheet 1 could, for example, be formed of paper into which the photosensitive layer 45 and the photosensitive film 57, respectively, are embedded in strip or field form (FIG. 5b). Another alternative is in the production of herein previously described multiple blanks of the photosensitive film 57, which can then be cut up and adhesively bonded onto any desired printing products, for example, paper or other products. This is a particularly cost-effective method, because several hundreds to a thousand blanks per printed sheet can be produced. However, the photosensitive film has to be cut to size, at considerable expense, after the exposure operation and then adhesively bonded in an additional operation.

The following list is intended to provide an exemplary overview of possible applications of the information carrier according to the invention. In this regard, the information which is stored can be, for example, animation, graphics, advertising, product information, production sequence, installation advice, software, as well as data:

packagings and labels of all types,

drug packages and in-pack leaflets,

advertising brochures of all types,

supplements to periodicals and magazines,

business and advertising letters,

entry tickets, business cards,

product identification via a self-adhesive label, and also

direct multimedia advertising on the product itself.

With the reader illustrated in FIG. 6, the purchaser can, for example, read the label provided with the digital information and the attached poster, respectively, and in this manner obtain information about the product even before making his purchase decision. This may assist in sales, in particular, of products requiring an explanation, or of expensive products. Examples of an application thereof are music CDs or DVD films. The purchaser can learn about the pictures and sound belonging to the respective CD or film simply and quickly by reading the digital label, without opening the package.

The information stored on the photosensitive film 57 (FIG. 5) can be read via a handy hand-held reader 61, which is suitable for multimedia and preferably also permits a link to a PC. For this purpose, the hand-held reader 61 has a reading unit in the form of a combined photodiode-laser unit 65 behind an optical window 67 formed in a housing 63. The reading unit 65 is connected to a control unit 69, which is, in turn, connected to an input unit 71 and a flat-screen monitor 73 and, if necessary or desirable, to a non-illustrated loudspeaker. The user simply places the device 61, which is about the same size as a pack of cigarettes, on the storage region of the paper document 55, and activates the reading operation. The laser transmits light onto the photosensitive layer, the light being reflected in accordance with the information stored during the exposure operation, and detected by the photodiode unit. Following the decoding of the digital information, graphics or pictures, sound, film and information can be output thereby. If the two-dimensional extent of the storage region of the photosensitive film 57 is greater than the reading area of the reader 61, the user moves the device slowly over the reading area. If necessary or desirable, a touch-screen monitor is provided, by which interactive user control is realizable. For the purpose of linking to a PC, for example, the device 61 has a suitable interface 75 (FIG. 6).

I claim:

1. An information transfer device, comprising a rotary main cylinder, a rotary guide cylinder pressed against said rotary main cylinder, said cylinders defining a contact nip therebetween through which a recording material with photosensitive properties is guidable for transferring information, a non-rotary light source disposed in said main cylinder and directed towards said contact nip, said main cylinder having a periphery predominantly translucent to light from said light source, and a device for selectively inputting light into the recording material with photosensitive properties.

2. The information transfer device according to claim 1, further comprising an elastic cover layer disposed on a periphery of said rotary guide cylinder.

3. The information transfer device according to claim 1, wherein said light source is formed by a member selected from a group thereof consisting of a controlled laser and a diode line.

4. The information transfer device according to claim 1, wherein said light source is an emitter of UV-light.

5. The information transfer device according to claim 1, wherein said device for selectively inputting light is an exposure mask having the information to be transferred, said exposure mask being held on said periphery of said main cylinder.

6. The information transfer device according to claim 5, wherein said exposure mask has a carrier plate being translucent to the light from said light source and whereon a mask structure is provided.

7. The information transfer device according to claim 6, wherein said mask structure is covered with a protective layer.

8. The information transfer device according to claim 5, wherein said exposure mask has a thickness of about 0.1 to 0.4 mm.

9. The information transfer device according to claim 5, wherein said exposure mask has a thickness of about 0.15 to 0.3 mm.

10. A method of transferring information, which comprises storing information on a photosensitive recording material, guiding the recording material between a rotating main cylinder and a rotating guide cylinder, and selectively exposing the recording material in a manner suitable for transferring the information in a contact nip between the two cylinders.

11. The method according to claim 10, which further comprises applying the photosensitive recording material to a sheet at least approximately similar to paper before exposing the recording material.

12. The method according to claim 10, which further comprises initially exposing the sheet in a modified printing unit, and then printing the sheet in a further printing unit.

13. A recording material serving as raw material for photosensitive storage and conventional printing with data, comprising, as a first data carrier, a printable first subarea region at least similar to one of paper and film and, as a photosensitive second data carrier, a second subarea region.

14. The recording material according to claim 13, wherein said second data carrier is embedded in said first data carrier.

15. A hand-held reader for information stored in a photosensitive data carrier, comprising a housing, a reading unit, an input unit and an output unit carried by said housing, and a control unit in said housing, said control unit interconnecting said reading unit, said input unit and said output unit.
